(19) United States
(12) Patent Application Publication
(10) Pub. No.: US 2008/0244892 A1
(43) Pub. Date: Oct. 9, 2008

(54) Method For Producing a Shaft Pertaining to a Starter

(75) Inventor: Celine Berthod, Montluel (FR)

Correspondence Address: MATTHEW R. JENKINS, ESQ., 2310 FAR HILLS BUILDING, DAYTON, OH, 45419, US

(73) Assignee: VALEO EQUIPEMENTS ELECTRIQUES MOTEUR, Creteil, Cedex (FR)

(21) Appl. No.: 10/599,217

(22) PCT Filed: May 19, 2005
(86) PCT No.: PCT/FR2005/001258

§ 371 Date: Sep. 22, 2006

(30) Foreign Application Priority Data
May 19, 2004 (FR) 0450992

(51) Int. Cl. B23P 13/04

(52) U.S. Cl. 29/557; 148/559

(57) ABSTRACT

A method for producing a shaft comprising a first section, a second channelled section, and a third section provided with an abutment shoulder surface for the starter, the method comprising the following steps: a) the three sections are machined; b) external grooves are produced in the second section; and c) at least one axial part of the starter shaft is subjected to a surface heating treatment. The invention is characterised in that the method comprises an additional step, prior to the heating treatment step, for reducing the residual mechanical stresses resulting from steps preceding the heating treatment. The additional step is a step for annealing, especially by induction heating, at least one axial part of the starter.

### BACKGROUND OF THE INVENTION

1. Field of the Invention

The present invention concerns a method of producing a motor vehicle starter head shaft.

2. Description of the Related Art

The method of manufacturing such a starter head shaft comprises the following steps:
machining in order to obtain the raw profile by means of a cutting tool on an automatic lathe;
producing, by cold deformation, external helical flutes and knurling on the rotor shaft for holding the packet of sheets of the rotor armature;
cleaning the shaft in order to eliminate the cutting oils and lubricants in order not to interfere with the subsequent heat treatment;
heat treatment by surface hardening by localized induction on a surface layer to its given depth according to the parameters of the program so as to modify and optimize the mechanical characteristics of the shaft, the shaft being for example held in a vertical position and the surface annealing by induction being carried out “on the run” by placing the shaft in rotation in an inductor that runs axially along the shaft (in a variant, the heat treatment can be carried out by means of a “form” inductor, static axially with respect to the shaft);
straightening the shaft, which is held by its ends, a force being applied locally in order to deform it plastically between these two points;
planing in order to eliminate the layer of scale formed during the heat treatment on the cylindrical surfaces of the shaft, and obtaining roughness, the final dimensions and the geometric specifications such as circular shape, concentricity, etc, on these areas.

Such a manufacturing method introduces residual stresses that essentially have two origins.

These are stresses of mechanical origin resulting from steps of the manufacturing process upstream of the heat treatment, that is to say stresses of thermal origin resulting from the surface hardening heat treatment.

These residual stresses are of a level such that cracking occurs initiated on the surface which is revealed by the induction surface hardening operation, through the exceeding of the mechanical characteristics of the material of the shaft in this area, which is a low-carbon steel whose carbon content is between 0.38% and 0.55%, and preferentially between 0.45% and 0.51%.

It was found that this cracking phenomenon resulted in particular in the appearance of circular cracks located in the third annular shoulder transverse face oriented towards the front, which constitutes a direct or indirect stop face, of the starter head.

What is needed, therefor, is an improved method of producing a steel starter head shaft.

### SUMMARY OF THE INVENTION

The invention concerns more particularly a starter head shaft for a starter of the type comprising a starter head comprising a starter pinion mounted so as to slide axially on the starter head shaft, between a rear idle position and a front working position, the starter head comprising a body, a sleeve on which is mounted so as to slide on the starter head shaft and the internal bore of which comprises a fluted portion whose internal flutes cooperate with the external flutes on a fluted portion of the starter head shaft. Stop means are also provided for limiting the axial sliding travel of the starter head pinion with respect to the starter head shaft towards at least one given rear axial idle position.

To this end, the steel starter head shaft comprises successively at least one first front guide portion sliding axially on the starter head, a second fluted intermediate portion comprising the external flutes able to cooperate with the complementary internal flutes on the starter head, and a third rear portion comprising at least one annular transverse shoulder face oriented towards the front, which constitutes a rear stop face for determining a given rear axial idle position of the starter head.

The starter head can cooperate directly with this annular stop face, which is for example planar and oriented radially, or indirectly through a ring or a stop washer that bears axially towards the rear against this stop face, which can for this purpose belong to an internal radial groove on the shaft in which the stop ring is mounted.

The starter head shaft can also be extended axially towards the rear in order to constitute the shaft of the rotor of the electric motor of the starter.

The invention proposes a method of producing a steel starter head shaft that comprises successively at least one first front guidance length sliding axially on a starter head, a second fluted intermediate length comprising external flutes able to cooperate with complementary internal flutes on the starter head, and a third rear length comprising at least one annular shoulder transverse face oriented towards the front, which constitutes a rear stop face for determining a determined axial position of the starter head, the method comprising at least the following successive steps:

a) machining the three first, second and third lengths;

b) producing the external flutes of the second intermediate length;

c) surface heat treatment of at least an axial part of the starter head shaft; characterized in that the method includes an additional step, prior to the heat treatment step, for reducing the residual mechanical stresses resulting from the steps prior to the heat treatment, notably from the machining step.

According to other characteristics of the invention:
the said additional step is a step of annealing at least an axial portion of the starter head shaft;
the additional step of annealing at least an axial portion of the starter head shaft is an operation of surface heating by induction along the said axial portion;
the additional step of annealing by surface heating by induction comprises a heating period during which the inductor is axially static with respect to the said portion of the starter head shaft;
the static heating period is between 0.5 seconds and 15 seconds;
the static heating period is between 1.9 seconds and 2.3 seconds and is preferably equal to 2.1 seconds;
the axial length of the inductor is substantially equal to the axial length of the said portion of the starter head shaft;
the axial length of the inductor is less than the axial length of the said portion of the starter head shaft, and the inductor is driven in axial translation with respect to the starter head shaft;
the relative axial translation speed of the inductor with respect to the starter head shaft is between 100 mm/minute and 700 mm/minute;
the relative axial translation speed of the inductor with respect to the starter head shaft is between 450 mm/minute and 550 mm/minute, and is preferably equal to 500 mm/minute;
the induction heating power is less than 10 kW;
the induction heating power is between 4.5 kW and 7 kW;
the starter head shaft is driven in rotation with respect to the inductor at a rotation speed of less than 200 rev/min;
the internal profile of the inductor is complementary to the external profile of the said starter head shaft portion;
according to another embodiment, the said additional step of annealing at least an axial portion of the starter head shaft is an operation of heating the starter head shaft in a furnace;
the heating temperature is between 500° C. and 700° C.;
the heating temperature is between 540° C. and 560° C., preferably equal to 550° C.;
the duration of the operation of heating the starter head shaft is between 30 minutes and 120 minutes;
the duration of the operation of heating the starter head shaft is between 55 minutes and 65 minutes, preferably equal to 60 minutes;
the operation of heating the starter head shaft in a furnace is an operation of heating at a constant temperature;
the operation of heating the starter head shaft in a furnace is followed by an operation of slow cooling to ambient temperature;
the said step c) of surface heat treatment of at least an axial part of the starter head shaft is a step of surface hardening by induction;
the said additional steps of surface heating by induction and surface hardening by induction are carried out successively with the same induction heating means;
the method comprises a step, subsequent to the surface heat treatment step, of mechanical straightening of at least an axial part of the starter head shaft;
the method comprises a step of planing certain portions of the surface of the starter head shaft that is subsequent to the step of surface heat treatment of at least an axial part of the starter head shaft;
the said annular shoulder transverse face oriented towards the front of the third rear portion of the starter head shaft belongs to an internal radial groove that receives a rear elastic stop ring for determining the said determined axial position of the starter head;
the starter head shaft is extended axially beyond the said third rear length in order to constitute the shaft of the rotor of the electric motor of the starter;
the rotor shaft comprises a knurled length produced by cold deformation, and the said additional step for reducing the residual mechanical stresses is subsequent to the step of production of the knurled length of the rotor shaft by cold deformation.

These and other objects and advantages of the invention will be apparent from the following description, the accompanying drawings and the appended claims.

### BRIEF DESCRIPTION OF THE ACCOMPANYING DRAWINGS

Other characteristics and advantages of the invention will emerge from a reading of the following detailed description, for an understanding of which reference should be made to the accompanying drawings, in which:

FIG. 1 is a view of a starter head shaft of a motor vehicle produced in accordance with the teachings of the invention;

FIG. 2 is a view similar to that in FIG. 1 that depicts an intermediate state of manufacture of the shaft in FIG. 1 after the automatic lathe machining operations; and

FIG. 3 is a half view in axial section and to a larger scale of the third length T3 of the shaft in FIG. 1 in association with a schematic representation of induction heating means for performing the additional annealing step in accordance with the teachings of the invention.

### DETAILED DESCRIPTION OF THE PREFERRED EMBODIMENTS

In the following description and in the claims, a front-rear orientation will be adopted non-limitingly with reference to the left-right orientation in the figures.

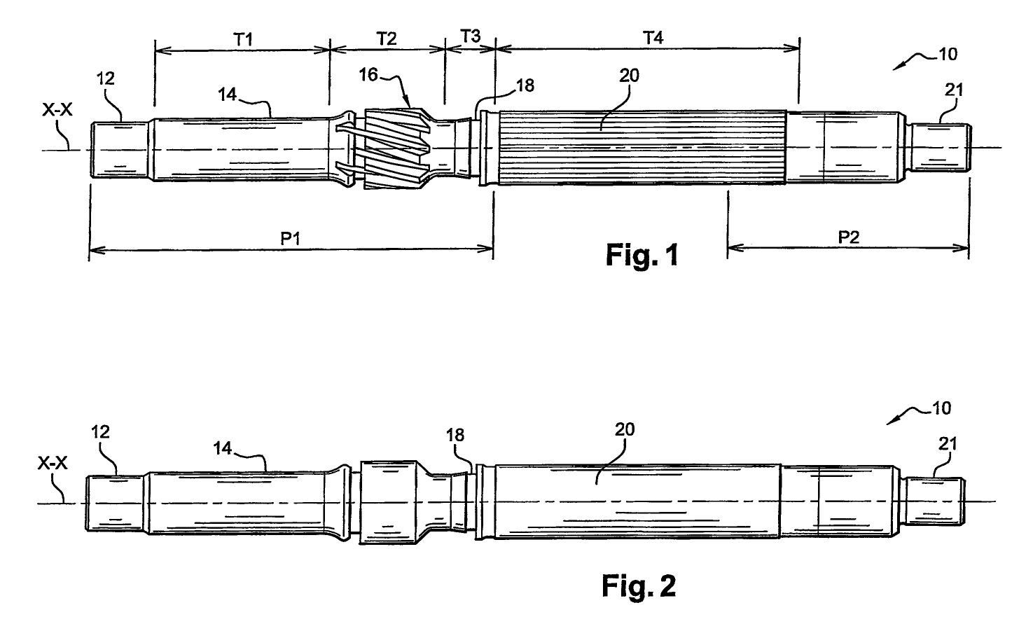

FIG. 1 depicts a starter head shaft 10, also referred to as a starter shaft, which is in the form of a cylindrical piece of axis X-X extending from front to rear.

In a known manner, in this example embodiment, the shaft 10 comprises, successively from front to rear, a first smooth front axial end length 12 for the rotational guidance of the shaft 10 in a front bearing, not shown, belonging to a housing element or starter nose, a smooth length 14 for slideably guiding the starter head, not shown, of the starter, external helical flutes 16 intended to cooperate with internal flutes, not shown, on the starter head in order to connect the latter rotationally to the shaft 10, an internal radial groove 18 is intended to receive an axial stop ring, not shown, in order to define or delimit a so-called idle rear axial position of the starter head.

The lengths 12, 14, 16 and 18 constitute the starter head shaft proper. The starter head shaft is extended axially here towards the rear by a knurled length 20 that is intended to receive a packet or stack of metal sheets, not shown, belonging to the armature of the electric motor of the starter.

Finally, the shaft 10 terminates in a smooth rear axial end length 21 which, like the length 12, rotationally guides the shaft 10 in a rear bearing of the starter.

Within the meaning of the invention, there are defined successively, as indicated in FIG. 1, the first front axial length T1, which corresponds to the length 14, the second intermediate axial length T2, which comprises the flutes 16, the third rear axial length T3, and finally the rear axial length T4, which extends the starter head shaft beyond the length T3 and which corresponds overall to the knurled length 20.

As can be seen in FIG. 3, the groove 18 in the rear length T3 is delimited axially towards the rear by a radially oriented transverse face 22 oriented towards the front, which extends radially towards the outside as far as a cylindrical surface 24 with a larger outside diameter D1, which is here for example equal to 13 millimeters, of the length T3.

The groove 18 is also delimited axially towards the front by a radially oriented transverse face 26 oriented towards the rear which extends radially towards the outside as far as a smaller outside diameter of that D1 of the face 22.

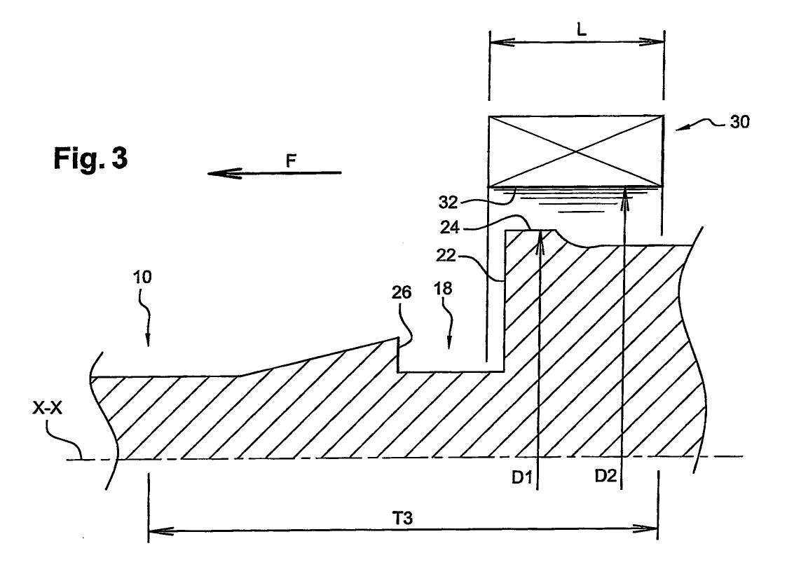

In a known fashion, the manufacture of the shaft begins with the automatic lathe machining of a steel “blank” or billet in order to end up with the rough piece illustrated in FIG. 2 which, if it is compared with the shaft in FIG. 1, does not yet comprise the flutes 16 nor the knurling 20 on the length T4.

The cylindrical profile of the billet is modified by removing material with a cutting tool on an automatic lathe. This operation produces residual stresses on the surface of the shaft 10, in particular on the rear transverse face 22 (see FIG. 3) oriented towards the front of the groove 18 intended to receive a stop ring. These stresses appear over a depth of a few microns.

The flutes 16 and the knurling 20 are produced by cold deformation, or in a variant by removal of material.

The forms of the helical flutes 16 which, in a manner known for example from the document FR-2.745.855, also fulfill a function of forward axial stop for the starter head, and the knurling shapes, are obtained by a series of operations of cold deformation of the turned surface of the corresponding lengths of the shaft by passing a rack whilst applying a pressure. This operation introduces additional residual stresses within the material over a depth of several millimeters. It is also possible to obtain these shapes by using cylindrical knurled wheels or by removal of material.

The manufacture can then comprise a washing step, which is an operation of cleaning the shaft in order to eliminate the cutting oils and lubricants in order not to interfere with the subsequent heat treatment.

In accordance with the teachings of the invention, the method of manufacturing the shaft 10 comprises an additional annealing step with a view to obtaining a relaxation of the residual stresses mentioned above that result from the mechanical conversion steps and that give rise to the appearance of unacceptable cracks.

The relaxing or “detensioning” annealing heat treatment according to the invention reduces or eliminates the residual mechanical stresses in the piece in order to remain within acceptable limits for the material in order to continue the subsequent operations of the known manufacturing method.

It is possible to perform the relaxation annealing step using an installation for heating in the mass such as a furnace (not shown) or by means of an induction surface heating installation.

In the first case and according to a first embodiment of the invention, the relaxation annealing heat treatment is carried out over the entire piece.

The reduction in the residual stresses is obtained by performing the following operations:
an operation of heating the entire shaft up to a temperature of between 500° C. and 700° C., preferably equal to 550° C.±10° C. in order not to have any modification to the microstructure of the shaft body;
isothermal maintenance at this heating temperature for 30 minutes to 120-minutes, preferable for 60 minutes, the duration of heating depending in particular on the load placed in the furnace for a relaxation heating cycle;
a slow cooling operation in calm air or in the furnace.

In the second case of superficial heating, or on the surface, by induction, the expected effect of the reduction in the residual stresses without modification to the microstructure can be obtained by performing a relaxation annealing heat treatment by induction on all or part of the shaft 10, and preferably the length T3 defined in FIG. 1, in particular in order to reduce the duration of this additional step according to the invention of relaxation annealing of the residual stresses.

This solution has the advantage of being integrated in the manufacturing cycle on the one hand and being able to be performed with the installation for surface hardening heat treatment by induction already used in the manufacturing method, the frequency of which is below 400 kHz and preferably between 320 and 360 kHz.

To do this, and as can be seen in FIG. 3, there is for example provided an annular inductor 30 whose effective axial heating length L is for example around 5 mm and whose inside diameter D2 is such that there exists a radial clearance or air gap of between 1 mm and 3 mm between its internal concave cylindrical surface 32, and preferably equal to 2.5 mm, and the facing convex cylindrical surface of the surface 24.

The inductor and the shaft have a “fixed” relative axial position defined so that the heating zone corresponds, as illustrated in FIG. 3, to the shoulder 22 of the groove 18.

This relative axial position of the inductor 30 with respect to the shaft 10 is kept “fixed” for a static warming, or heating, of between 0.5 seconds and 15 seconds, and preferably equal to 2.1 seconds, during which the inductor is supplied with a power less than or equal to 10 kilowatts, and preferably between 4.5 kilowatts and 7 kilowatts.

During this static heating phase, the shaft 10 is driven in rotation about its rotation axis X-X at a speed of rotation of less than 200 rev/min.

Next the inductor is moved axially forward in the direction of the arrow F in FIG. 3 along the shaft 10 at a speed of movement of between 100 and 700 millimeters per minute, preferably equal to 500 mm/minute, passing successively over the various zones that follow the shoulder 22 towards the front along the length T3.

The speed of movement of the inductor depends on the power supplied by the inductor.

During the movement, that is to say the relative movement of the inductor 30 along the shaft 10, the latter is also preferably driven in rotation as specified above and the power of the conductor is less than or equal to 10 kilowatts, and preferably between 4.5 kilowatts and 7 kilowatts.

By way of variant, it is possible to use an inductor whose effective heating length L is sufficient to “encompass” the entire zone to be annealed, for example the whole of the length T3, the relaxation annealing then taking place by simple static heating.

The inductor can also be an inductor with a shape or internal profile complementary to that of the length of the shaft to be annealed.

After having proceeded with the relaxation annealing step in accordance with the teachings of the invention, the manufacture of the shaft 10 continues in a known manner with a heat treatment step consisting of induction surface heating of the front P1 and rear P2 axial parts indicated in FIG. 1.

As stated in the preamble, this is a hardening heat treatment located on a surface layer up to a given depth.

The surface toughening operation on the rear part P2 of the shaft 10 can advantageously be carried out on the same induction heating station as that used for the relaxation annealing step according to the invention.

The localized hardening heat treatment operation also and once again causes residual stresses of thermal origin in the material but, if this step is correctly carried out, the total of the residual stresses does not reach a sufficient value to result in the formation of cracks as is the case with the residual stresses of mechanical origin mentioned previously.

The surface hardening annealing by induction can also be carried out “in movement” or with a shape inductor.

The method can then comprise a straightening step during which the shaft is held by its ends and the forces applied in a localized fashion in order to deform it plastically between these two points and finally the planing step with a view to removing the layer of scale formed during the heat treatment on the surfaces 12 and 22 of the shaft 10.

The invention can be applied to any portion of the shaft in which it is wished to achieve a relaxation or releasing of the mechanical stresses.

While the method herein described, the part and the form of apparatus for carrying this method into effect, constitute preferred embodiments of this invention, it is to be understood that the invention is not limited to this precise method, part and form of apparatus, and that changes may be made in either without departing from the scope fo the invention, which is defined in the appended claims.

What is claimed is:

1. A method of producing a steel starter head shaft that comprises successively at least one first front guidance length sliding axially on a starter head, a second fluted intermediate length comprising external flutes able to cooperate with complementary internal flutes on the starter head, and a third rear length comprising at least one annular shoulder transverse face oriented towards the front, which constitutes a rear stop face for determining a determined axial position of the starter head, the method comprising at least the following successive steps:
a) machining the three first, second and third lengths;
b) producing the external flutes of the second intermediate length;
c) surface heat treatment of at least an axial part of the starter head shaft;
characterized in that the method includes an additional step, prior to the heat treatment step, of reducing the residual mechanical stresses resulting from the steps prior to the heat treatment.

2. The method according to claim 1, characterized in that the said additional step is a step of annealing at least an axial portion of the starter head shaft.

3. The method according to claim 2, characterized in that the additional step of annealing at least an axial portion of the starter head shaft is an operation of surface heating by induction along the said axial portion.

4. The method according to claim 3, characterized in that the additional step of annealing by surface heating by induction comprises a heating period during which the inductor is axially static with respect to the said portion of the starter head shaft.

5. The method according to claim 4, characterized in that the static heating period is between 0.5 seconds and 15 seconds.

6. The method according to claim 4, characterized in that the axial length of the inductor is substantially equal to the axial length of the said portion of the starter head shaft.

7. The method according to claim 3, characterized in that the axial length of the inductor is less than the axial length of the said portion of the starter head shaft, and the inductor is driven in axial translation with respect to the starter head shaft.

8. The method according to claim 7, characterized in that the relative axial translation speed of the inductor with respect to the starter head shaft is between 100 mm/minute and 700 mm/minute.

9. The method according to claim 3, characterized in that the induction heating power is less than 10 kW.

10. The method according to claim 3, characterized in that the starter head shaft is driven in rotation with respect to the inductor at a rotation speed of less than 200 rev/min.

11. The method according to claim 6, characterized in that the internal profile of the inductor is complementary to the external profile of the said starter head shaft portion.

12. The method according to claim 2, characterized in that said additional step of annealing at least an axial portion of the starter head shaft is an operation of heating the starter head shaft in a furnace.

13. The method according to claim 12, characterized in that the heating temperature is between 500° C. and 700° C.

14. The method according to claim 12, characterized in that the duration of the operation of heating the starter head shaft is between 30 minutes and 120 minutes.

15. The method according to claim 12, characterized in that the operation of heating the starter head shaft in a furnace is an operation of heating at a constant temperature.

16. The method according to claim 12, characterized in that the operation of heating the starter head shaft in a furnace is followed by an operation of slow cooling to ambient temperature.

17. The method according to claim 1, characterized in that the said step of surface heat treatment of at least an axial part of the starter head shaft is a step of surface hardening by induction.

18. The method according to claim 17 taken in combination with claim 3, characterized in that the said additional steps of surface heating by induction and surface hardening by induction are carried out successively with the same induction heating means.

19. The method according to claim 1, characterized in that the method comprises a step, subsequent to the surface heat treatment step, of mechanical straightening of at least an axial part of the starter head shaft.

20. The method according to claim 1, characterized in that the method comprises a step of planing certain portions of the surface of the starter head shaft that is subsequent to the step of surface heat treatment of at least an axial part of the starter head shaft.

21. The method according to claim 1, characterized in that the said annular shoulder transverse face oriented towards the front of the third rear portion of the starter head shaft belongs to an internal radial groove that receives a rear elastic stop ring for determining the said determined axial position of the starter head.

22. The method according to claim 1, characterized in that the starter head shaft is extended axially beyond the said third rear length in order to constitute the shaft of the rotor of the electric motor of the starter.

23. The method according to claim 22, characterized in that the rotor shaft comprises a knurled length produced by cold deformation, and in that the said additional step for reducing the residual mechanical stresses is subsequent to the step of production of the knurled length of the rotor shaft by cold deformation.
